(19) United States
(12) Patent Application Publication
(10) Pub. No.: US 2026/0094402 A1
(43) Pub. Date: Apr. 2, 2026

(54) IMAGE PROCESSING METHOD, IMAGE PROCESSING DEVICE, AND RECORDING MEDIUM

(71) Applicant: CANON MEDICAL SYSTEMS CORPORATION, Tochigi (JP)

(72) Inventors: Shuolin LIU, Beijing (CN); Bing HAN, Beijing (CN); Yufei LI, Beijing (CN)

(73) Assignee: CANON MEDICAL SYSTEMS CORPORATION, Tochigi (JP)

(21) Appl. No.: 19/342,358

(22) Filed: Sep. 26, 2025

(30) Foreign Application Priority Data
Sep. 29, 2024 (CN) 202411379537.3
Sep. 22, 2025 (JP) 2025-156808

(51) Int. Cl. G06V 10/25; G06V 10/26; G06V 10/778; G06V 10/94

(52) U.S. Cl. CPC G06V 10/25; G06V 10/26; G06V 10/7788; G06V 10/945; G06V 2201/03

(57) ABSTRACT

An image processing method according to the present embodiment is a method for performing an inference task on image data using a trained deep learning model in which a plurality of patch parameters are first set corresponding to the inference task. Next, a plurality of patches are generated for each of the patch parameters, an inference result based on the generated patches is acquired, and an optimized patch parameter and patches corresponding to the optimized patch parameter are determined from among the patch parameters based on the inference result. Next, the inference task is performed by using the deep learning model to acquire an inference result based on the patches corresponding to the determined optimized patch parameter.

### CROSS-REFERENCE TO RELATED APPLICATIONS

This application is based upon and claims the benefit of priority from Chinese Patent Application No. 202411379537.3, filed on Sep. 29, 2024; and Japanese Patent Application No. 2025-156808, filed on Sep. 22, 2025, the entire contents of all of which are incorporated herein by reference.

### FIELD

Embodiments described herein relate generally to an image processing method, an image processing device, and a recording medium.

### BACKGROUND

Deep learning is an algorithm that performs feature learning on data based on a neural network. An object of the feature learning is to construct a better deep learning model by obtaining a better representation method for data to learn the representation method based on large-scale unlabeled data. The deep learning is especially applied to an image processing task, and a favorable result can be obtained. In the image processing task, the deep learning can be used for image processing such as segmentation, classification, and detection performed on an image.

However, conventional deep learning has various problems. For example, a deep learning model typically requires a large number of parameters, has a complex computational graph, and requires a large amount of computational resources for a task of segmenting a high-resolution three-dimensional image, so that an inference time is increased. In a clinical environment, in decision-making for diagnosis and treatment, typically, an image processing result needs to be quickly obtained, and there is a requirement for a response speed of the deep learning model. Additionally, a hardware device such as an embedded or mobile platform on a medical device typically includes limited computational resources, so that it is difficult to execute a segmentation model based on complex deep learning on a device such as a mobile medical device or a handheld ultrasonic device by way of example.

To solve the various problems described above, the following conventional techniques have been developed.

As one conventional technique, a deep learning model is improved by using a Sliding-Window method. In this method, based on a Sliding-Window format, a complete image is segmented into fixed-size patches, the deep learning model is caused to perform inference in each of the segmented patches, and inference results in the respective patches are fused into a final inference result. According to such a method, it is possible to avoid a problem of insufficient computational resources required for performing inference on a complete image.

In another conventional technique, the deep learning model is improved by using a Coarse-to-fine method. In this method, first, a key target region is specified by using a coarse model, and inference is performed in the key target region by using a fine model thereafter. With such a method, an inference speed can be improved by reducing processing in a background region.

There is also known a technique called Model Compression in which a computational amount of the model is reduced by reducing the number of parameters of the deep learning model, pruning, quantization, or using a lightweight model architecture. There is also known a technique of lowering complexity of computation by distilling a complex deep learning model into a simplified model, and improving the inference speed while maintaining performance of the deep learning model.

Furthermore, there is known a technique obtained by combining the Sliding-Window method and the Coarse-to-fine method (Coarse-to-fine+Sliding-Window) for generating the same patch for different tasks or targets by using patch parameters such as an aspect ratio and a length set in advance.

Thus, such techniques have a problem in that it is difficult to acquire an optimum inference result when faced with volumes, shapes, or needs of different tasks or targets, and redundancy of computation and an increase in inference time are caused. For example, in the conventional technique described above, typically, the same patch is generated for different tasks or targets by using patch parameters such as an aspect ratio and a length set in advance, so that it is difficult to acquire an optimum inference result when faced with volumes, shapes, or needs of different tasks or targets, and redundancy of computation and an increase in inference time are caused.

### BRIEF DESCRIPTION OF THE DRAWINGS

FIG. 1 is a block diagram illustrating a configuration example of an image processing system according to a first embodiment;

FIG. 2 is a block diagram illustrating a configuration example of an image processing device according to the first embodiment;

FIG. 3 is a schematic diagram illustrating input images of different patch parameters;

FIG. 4 is a graph illustrating a relation between a patch size ratio and accuracy of an inference result;

FIG. 5A is a schematic diagram illustrating planning of a plurality of patches;

FIG. 5B is a schematic diagram illustrating planning of a plurality of patches;

FIG. 5C is a schematic diagram illustrating planning of a plurality of patches;

FIG. 5D is a schematic diagram illustrating planning of a plurality of patches;

FIG. 5E is a schematic diagram illustrating planning of a plurality of patches;

FIG. 5F is a schematic diagram illustrating planning of a plurality of patches;

FIG. 6 is a graph illustrating a relation between a time and accuracy of an inference result;

FIG. 7 is a schematic diagram illustrating a user interface for editing patches by an editing function;

FIG. 8 is a flowchart illustrating an image processing method according to the first embodiment;

FIG. 9 is a flowchart illustrating planning of patches according to the first embodiment;

FIG. 10 is a block diagram illustrating a configuration example of an image processing device according to a second embodiment;

FIG. 11 is a schematic diagram illustrating an example of clinical data and critical information;

FIG. 12 is a block diagram illustrating a configuration example of an image processing device according to a third embodiment;

FIG. 13 is a flowchart illustrating model update by a model update function;

FIG. 14A is a schematic diagram for explaining differences between planning of patches according to a comparative example and planning of patches by the image processing method according to the present embodiment, and is a diagram illustrating a plurality of patches planned in the comparative example;

FIG. 14B is a schematic diagram for explaining differences between planning of patches according to the comparative example and planning of patches by the image processing method according to the present embodiment, and is a diagram illustrating a plurality of patches planned in the comparative example; and

FIG. 14C is a schematic diagram for explaining differences between planning of patches according to the comparative example and planning of patches by the image processing method according to the present embodiment, and is a diagram illustrating a plurality of patches planned in the image processing method according to the present embodiment.

### DETAILED DESCRIPTION

An image processing method according to the present embodiment is a method for performing an inference task on image data using a trained deep learning model, and includes: setting a plurality of patch parameters corresponding to the inference task; planning by generating a plurality of patches for each of the patch parameters, acquiring an inference result based on the generated patches, and determining an optimized patch parameter and patches corresponding to the optimized patch parameter from among the patch parameters based on the inference result; and inferring by performing the inference task using the deep learning model to acquire an inference result based on the patches corresponding to the determined optimized patch parameter.

The following describes embodiments of an image processing method, an image processing device, and a recording medium with reference to the attached drawings.

### First Embodiment

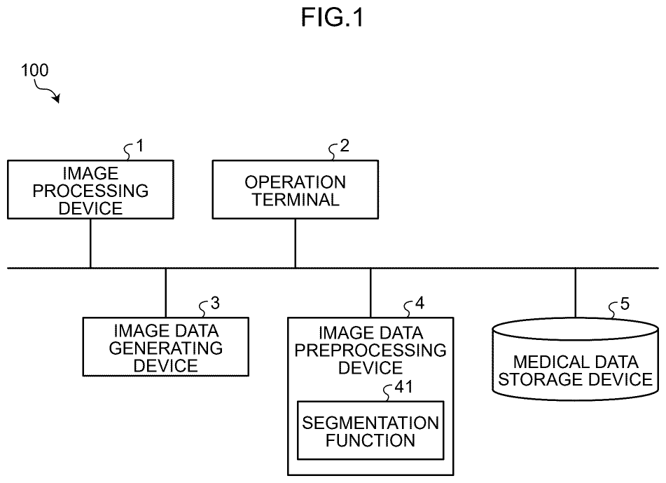

With reference to FIG. 1, the following describes a configuration example of an image processing system 100. FIG. 1 is a block diagram illustrating a configuration example of the image processing system 100 according to a first embodiment.

The image processing system 100 includes an image processing device 1, an operation terminal 2, an image data generating device 3, an image data preprocessing device 4, and a medical data storage device 5. The respective devices are connected to each other in a communicable manner via a common signal transmission path, for example, a bus or a network.

The image processing device 1 is a device configured to perform an inference task, by using a trained deep learning model, on image data of a medical image generated by the image data generating device 3. The image processing device 1 functions as a server in the image processing system 100, for example, and the image processing device 1 may be a workstation that can perform high-speed information processing.

The operation terminal 2 is a terminal operated by an operator (for example, a doctor or a technician). The operation terminal 2 functions as a client in the image processing system 100. The operation terminal 2 may be a computer, a notebook computer, a smartphone, a tablet terminal or a wearable terminal, a mobile terminal or a handheld terminal, or the like.

The operation terminal 2 may display, for example, a user interface UI (described later) to be able to be operated, input, or edited by a user.

The operation terminal 2 may include an input interface configured to receive various operations from the user. The input interface converts various operations received from the operator into electric signals, and transmits the electric signals to processing circuitry of the operation terminal 2. The input interface of the operation terminal 2 may be a mouse, a keyboard, a button, a panel switch, a slider switch, a trackball, an operation panel, or a touch panel.

The operation terminal 2 may also include a display configured to display various kinds of data and information. Examples of the display include a liquid crystal display, a plasma display, an organic electro-luminescence (organic EL) display, a light emitting diode (LED) display, and the like. The display may be a touch panel display that also functions as an input interface.

The image data generating device 3 is a device configured to generate image data of a medical image (hereinafter, abbreviated as “image data”). The image data generating device 3 may be a medical image diagnostic device (for example, an X-ray diagnostic device, an X-ray computed tomography (CT) device, a magnetic resonance imaging (MRI) device, an ultrasonic diagnostic device, a nuclear medicine examination device, and the like). The image data generating device 3 transmits the generated image data to the medical data storage device 5.

The image data preprocessing device 4 is a device configured to preprocess image data. The image data preprocessing device 4 includes processing circuitry (not illustrated), and a memory (not illustrated) configured to store computer programs that cause the processing circuitry to implement respective functional units. For example, the processing circuitry includes a segmentation function 41. Herein, the segmentation function 41 is an example of “segmenting”.

The segmentation function 41 segments image data by distinguishing between a region of interest and a region of non-interest. As a result of segmentation, for example, the segmentation function 41 segments the image data into a bone region as the region of interest, and the other region including a blood vessel region as the region of non-interest. In this manner, the segmentation function 41 segments the image data to extract the region of interest. A position of each segmented region can be represented as position information in a subject coordinate system of the image data. A known image recognition technique can be applied to segmentation by the segmentation function 41. For example, a region in which a CT value is larger than 150 HU in the image data may be segmented as the region of interest by applying a threshold algorithm, or the region of interest may be segmented by applying coarse segmentation or a detection model (for example, an nnUNet Coarse model). The image data preprocessing device 4 transmits a preprocessing result obtained by the segmentation function 41 to the medical data storage device 5.

The medical data storage device 5 is a device configured to store medical data. The medical data storage device 5 stores, for example, image data, clinical data (described later), an inference result based on a deep learning model, an editing result by the user, and the like. The medical data storage device 5 may be a storage medium (for example, a magnetic storage medium, an electromagnetic storage medium, an optical storage medium, or a semiconductor memory), or a drive device configured to read/write information from/to the storage medium. The medical data storage device 5 stores the image data transmitted from the image data generating device 3 and the preprocessing result transmitted from the image data preprocessing device 4.

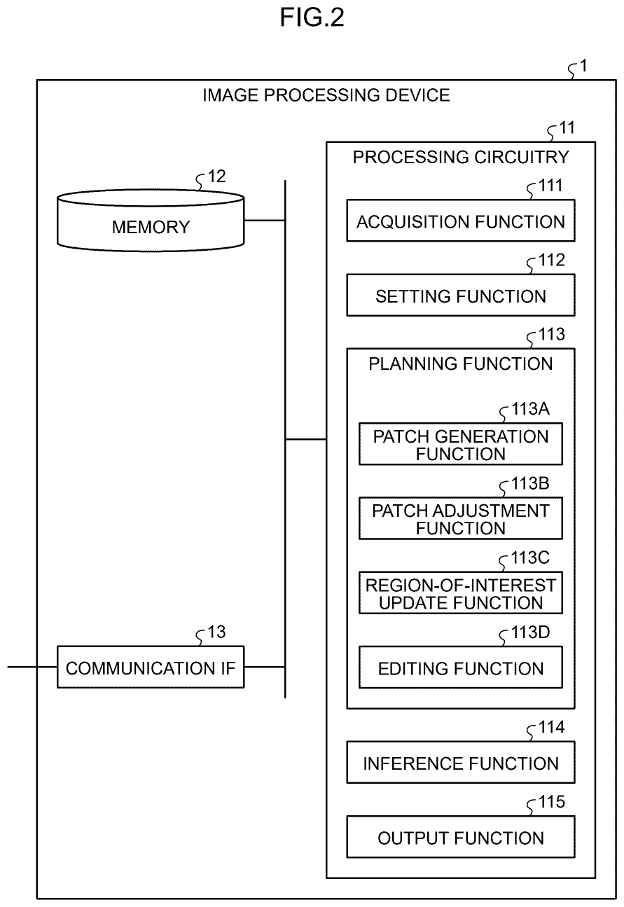

With reference to FIG. 2, the following describes a configuration example of the image processing device 1. FIG. 2 is a block diagram illustrating the configuration example of the image processing device 1 according to the first embodiment.

The image processing device 1 includes processing circuitry 11, a memory 12, and a communication IF 13. The respective configurations are connected to each other in a communicable manner via a bus as a common signal transmission path.

The memory 12 is a device configured to store various kinds of data and information. The memory 12 may be a storage medium that can be read by a processor (for example, a magnetic storage medium, an electromagnetic storage medium, an optical storage medium, or a semiconductor memory), or a drive device configured to read/write data or information from/to the storage medium. The memory 12 stores computer programs that cause the processing circuitry 11 to implement respective functional units.

The communication IF 13 is an interface configured to communicate various kinds of data and information with the configurations included in the image processing system 100. The communication IF 13 communicates various kinds of data and information with the operation terminal 2 or the medical data storage device 5.

The processing circuitry 11 is a circuit configured to control the entire operation of the image processing device 1. The processing circuitry 11 includes at least one processor. The processor means a circuit such as a central processing unit (CPU), a graphics processing unit (GPU), an application specific integrated circuit (ASIC), and a programmable logic device (examples: a simple programmable logic device (SPLD), a complex programmable logic device (CPLD), and a field programmable gate array (FPGA)). In a case in which the processor is a CPU, the CPU implements functions by reading out and executing respective computer programs stored in the memory 12. In a case in which the processor is an ASIC, each function is directly incorporated as a logic circuit in a circuit of the ASIC. The processor may be configured as a single circuit, or may be configured by combining a plurality of independent circuits with each other. The processing circuitry 11 implements a function of each functional unit (described later).

As illustrated in FIG. 2, the processing circuitry 11 includes an acquisition function 111, a setting function 112, a planning function 113, an inference function 114, and an output function 115. Herein, the acquisition function 111 is an example of “acquiring”. The setting function 112 is an example of “setting” and a “setting unit”. The planning function 113 is an example of “planning” and a “planning unit”. The inference function 114 is an example of “inferring” and an “inference unit”. The output function 115 is an example of “outputting”.

The acquisition function 111 acquires various kinds of data and information. For example, the acquisition function 111 acquires the image data, and acquires a result of the region of interest and the region of non-interest obtained by segmenting the image data by the segmentation function 41. The acquisition function 111 can acquire various kinds of data and information by accessing the medical data storage device 5.

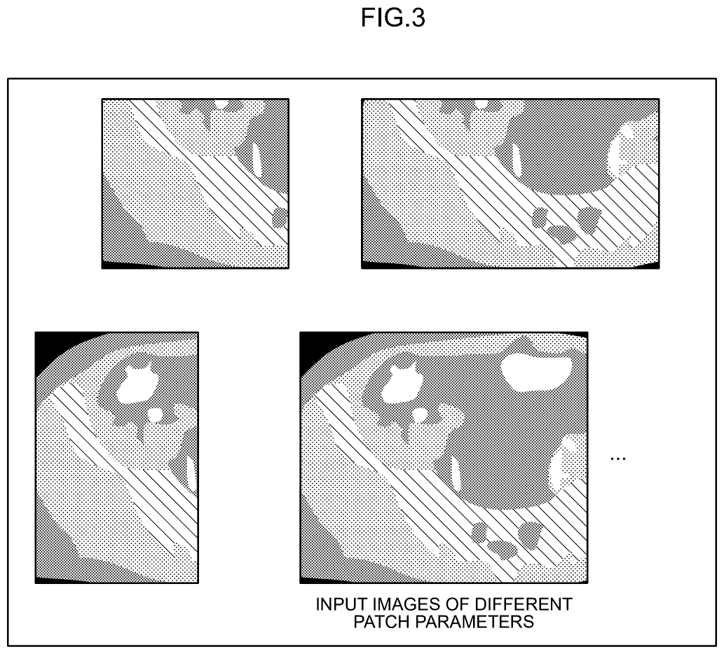

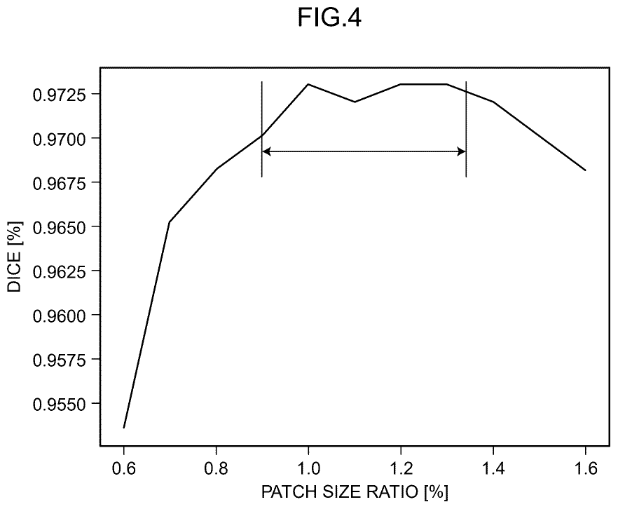

With reference to FIG. 3 and FIG. 4, the following describes setting of a recommended value for a patch parameter by the setting function 112. FIG. 3 is a schematic diagram illustrating input images of different patch parameters. FIG. 4 is a graph illustrating a relation between a patch size ratio and accuracy of an inference result.

The setting function 112 sets a plurality of patch parameters corresponding to an inference task performed by the deep learning model. Herein, the patch parameters include, for example, a base patch size, a patch size ratio, base resolution, and a resolution ratio. The patch parameter may be a parameter that determines a position, a size, and resolution of another patch.

The setting function 112 sets recommended values for the respective patch parameters. Herein, in a case in which the patch parameters include, for example, the base patch size, the patch size ratio, the base resolution, and the resolution ratio, the recommended values for the respective patch parameters are, for example, the base patch size=(128, 128, 128), the patch size ratio=0.9 to 1.35, the base resolution=(1.0, 1.0, 1.0), and the resolution ratio=0.9 to 1.3. The first embodiment describes an example in which the recommended value for the patch parameter falls within a range of a value of the patch parameter, but the recommended value for the patch parameter may be a certain specific value of the patch parameter.

Specifically, the setting function 112 sets the recommended values for the patch parameters based on parameters associated with an inference task performed by the deep learning model in a history database DB stored in the medical data storage device 5. For example, the setting function 112 sets the recommended values for the respective patch parameters based on parameters of organ segmentation data included in the history database DB stored in the medical data storage device 5. Herein, the organ segmentation data is an inference result of a segmentation inference task performed by the deep learning model, and the inference task performed by the deep learning model may be a tumor detection task, a pulmonary lesion classification task, or the like.

The setting function 112 may set the recommended values for the patch parameters based on an input by the user to the operation terminal 2. For example, the user designates a base patch size, a patch size ratio, base resolution, and a resolution ratio as the patch parameters on the operation terminal 2, and inputs recommended values therefor by the operation terminal 2. The setting function 112 sets the recommended values for the patch parameters based on the input by the user.

The setting function 112 may generate a corresponding input image for each of the patch parameters at regular intervals in a preset range of the patch parameter, acquire an inference result of each input image, and determine the recommended value for the patch parameter based on the inference result.

Specifically, the following exemplifies determination of a recommended value for the patch size ratio. For example, assuming that the base patch size=(128, 128, 128), a series of corresponding input images are generated for each of patch size ratios at intervals of 0.05 in a preset range of the patch size ratio from 0.6 to 1.6, and an inference result of each input image is acquired. In this case, a length of the input image=base patch size*patch size ratio is satisfied. When the patch size ratio=1.0 is satisfied, the length of the input image=(128, 128, 128) is satisfied and accuracy of the inference result is 0.972, and when the patch size ratio=1.25 is satisfied, the length of the input image=(160, 160, 160) is satisfied and accuracy of the inference result is 0.971. Due to this, it is possible to obtain a series of corresponding input images generated for each of the patch parameters at regular intervals in the preset range as illustrated in FIG. 3.

The setting function 112 can also acquire a relation between the patch size ratio included in the patch parameters and accuracy “DICE (%)” of the inference result (what is called a “Dice coefficient”) as illustrated in FIG. 4. From the relation illustrated in FIG. 4, it can be found that the range of the patch size ratio that has little influence on the accuracy of the inference result is 0.9 to 1.35. Thus, the setting function 112 determines a recommended value for the patch size ratio to be 0.9 to 1.35. Similarly, the setting function 112 determines recommended values for the base patch size, the base resolution, and the resolution ratio.

Herein, a preset range of a priori determined patch size ratio is 0.6 to 1.6, but the preset range of the patch parameter may be determined by using another scheme. The regular interval of the patch size ratio is 0.05, but may be another interval. Both of the “preset range” and the “regular interval” of the patch parameter are not limited, and may be used for determining the recommended value for the patch parameter.

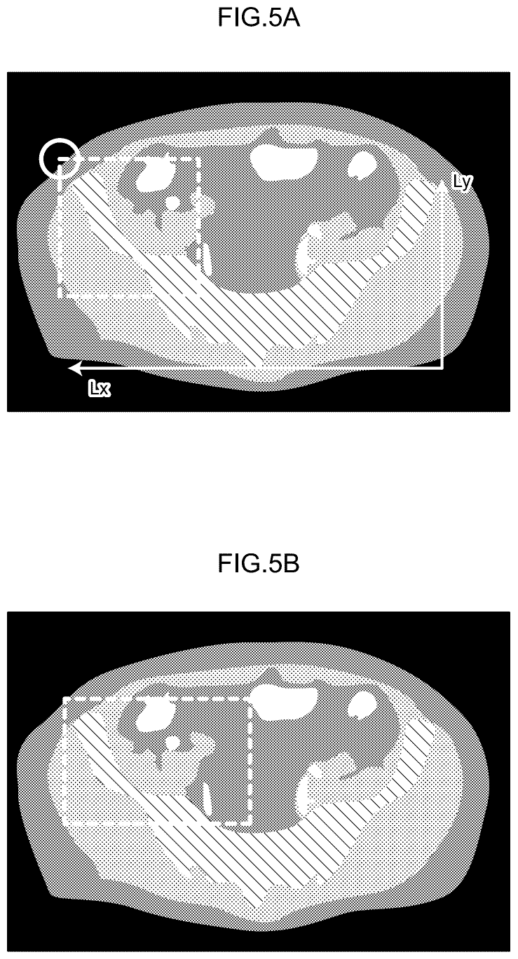

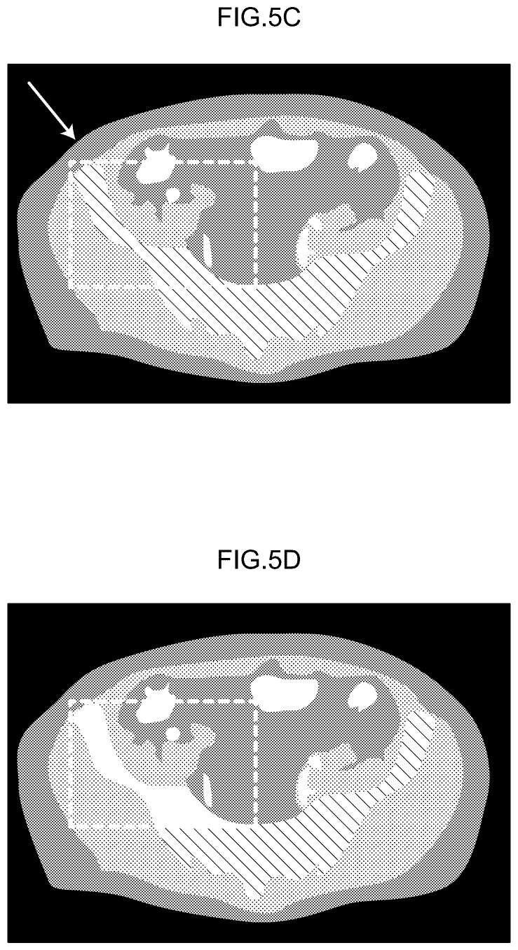

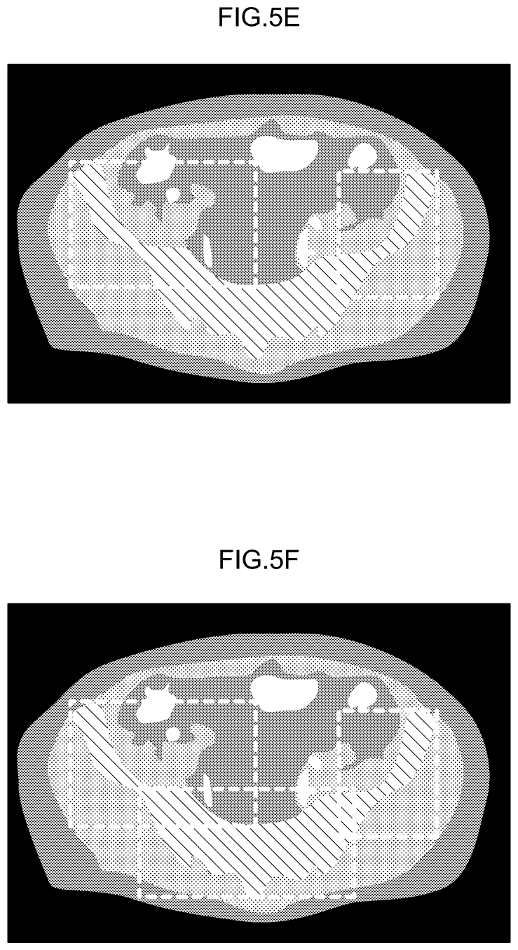

With reference to FIG. 5A to FIG. 5F, the following describes planning of patches by the planning function 113. FIG. 5A to FIG. 5F are schematic diagrams illustrating planning of a plurality of the patches.

The planning function 113 determines the patch parameter and plans the patches. Specifically, the planning function 113 generates the patches for each of the patch parameters.

The planning function 113 includes a patch generation function 113A, a patch adjustment function 113B, and a region-of-interest update function 113C. The patch generation function 113A, the patch adjustment function 113B, and the region-of-interest update function 113C are examples of “generating the patches”, “adjusting the patches”, and “updating a region of interest”, respectively.

The patch generation function 113A generates the patch for each of the patch parameters.

Specifically, as illustrated in FIG. 5A, the patch generation function 113A generates the patch (a dashed frame in FIG. 5A) at a position (a position indicated by a circle in FIG. 5A) of a corner point (also referred to as an angular point, an edge-corner point, or a vertex point) of a region of interest (oblique line region in FIG. 5A) output from the image data preprocessing device 4. Herein, the “corner point” of the region of interest indicates, for example, any of eight endpoints of a rectangle circumscribing the region of interest in FIG. 5F. The patch generation function 113A acquires these eight endpoints, and generates the patch at any of the endpoints. Herein, the patch generation function 113A generates, for example, the patch by selecting the endpoint having the smallest coordinate value on an XYZ coordinate system in which X, Y, and X axes are orthogonal to each other.

Next, the patch adjustment function 113B adjust the patch.

Specifically, as illustrated in FIG. 5B, the patch adjustment function 113B sets a patch size based on the patch parameter. Herein, for convenience of explanation, it is assumed that the base resolution=(1.0, 1.0, 1.0), the resolution ratio=1.25, and the base patch size*the patch ratio=(128, 128, 128), by way of example. To accelerate an inference process of the deep learning model by reducing the number of the patches, the patch adjustment function 113B adjusts the patch size corresponding to the length of the region of interest, that is, optimizes the patch size based on the length of the region of interest. At this point, assuming that lengths of the region of interest on the XYZ axes orthogonal to each other are (Lx, Ly, Lz), respectively, and the lengths (x, y, z) of the patch on the XYZ axes are adjusted based on the following formula 1 using the base patch size, the base resolution, the resolution ratio, a ceiling function (ceil), and an INT function (int).

$$x = int ( Lx / ceil ( Lx / ( base patch size * base resolution * resolution ratio ) ) ) \qquad ( Formula 1 )$$

$$y = int ( Lx / ceil ( Ly / ( base patch size * base resolution * resolution ratio ) ) )$$

$$z = int ( Lx / ceil ( Lz / ( base patch size * base resolution * resolution ratio ) ) )$$

Herein, “int” indicates rounding down, and “ceil” indicates rounding up. Due to this, the patch size is adjusted to be (110, 96, 148). Accordingly, the patch size can be adapted to the length of the region of interest.

As illustrated in FIG. 5C, the patch adjustment function 113B moves the position of the adjusted patch so that a range of the region of interest covered by the patch is increased while a range of the region of non-interest covered by the patch is reduced. Herein, first, it is ensured that the range of the region of interest that is first covered by the patch is not reduced, and subsequently, the position of the patch is adjusted so that the patch covers a larger area of the region of interest. Specifically, in FIG. 5B, an upper left portion of the patch covers an extra region of non-interest. Thus, in FIG. 5C, the patch is moved toward a lower right side so that the region of interest to be covered by the patch is increased and the region of non-interest to be covered thereby is reduced. Alternatively, the region of non-interest to be covered by the patch may be reduced by moving a left side and an upper side of the patch toward the lower right side to reduce the patch size.

Next, the region-of-interest update function 113C subtracts the patch from the region of interest of the image data and updates the region to a new region of interest.

Specifically, as illustrated in FIG. 5D, the region-of-interest update function 113C subtracts the patch indicated by the dashed frame from the region of interest indicated by the oblique line region in FIG. 5C, and updates the region of interest to the new region of interest indicated by an oblique line region in FIG. 5D.

Next, as illustrated in FIG. 5E and FIG. 5F, the planning function 113 generates a plurality of patches by executing the patch generation function 113A, the patch adjustment function 113B, and the region-of-interest update function 113C described above until a volume of the updated new region of interest becomes zero in the updated new region of interest. That is, the planning function 113 repeatedly performs steps of generating the patch by the patch generation function 113A, adjusting the patch by the patch adjustment function 113B, and updating the new region of interest by the region-of-interest update function 113C until the volume of the new region of interest, which is updated when the generated patches cover the entire region of interest, becomes zero in the updated new region of interest.

As illustrated in FIG. 5D to FIG. 5F, in the first cycle, the planning function 113 generates the patch indicated by a dashed frame in FIG. 5D. In the second cycle, the planning function 113 further generates the patch indicated by a dashed frame on a right side in FIG. 5E. In the third cycle, the planning function 113 further generates the patch indicated by a dashed frame at the center of FIG. 5F.

In the second cycle and cycles subsequent thereto, the patch generation function 113A generates the patch by selecting an endpoint different from the endpoint used in a previous cycle from among the eight endpoints of the rectangle circumscribing the region of interest.

The planning function 113 generates a plurality of patches for each patch parameter in the recommended values for the patch parameters set by the setting function 112. Due to this, the planning function 113 generates the patches as illustrated in FIG. 5F corresponding to each of the patch parameters.

The patch parameter, the size and the position of the patch, the number of cycles, the number of the patches, and the like are merely examples, and are not limited to the numerical values disclosed herein.

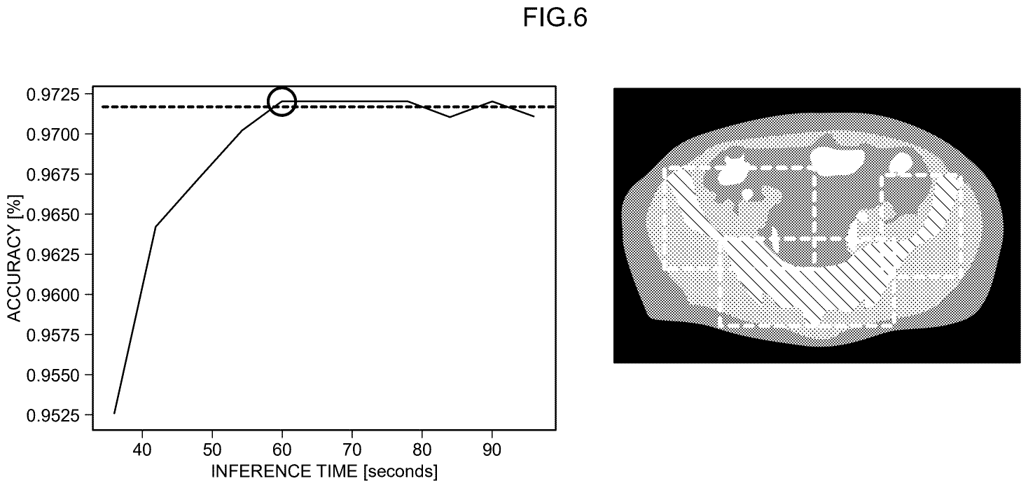

With reference to FIG. 6, the following describes a curve of a relation between a time (Inference time (seconds)) and accuracy (Accuracy (%)) of the inference result. FIG. 6 is a graph illustrating a relation between the time and the accuracy of the inference result.

Next, the planning function 113 acquires the inference result based on the generated patches, and determines an optimized patch parameter and a plurality of patches corresponding to the optimized patch parameter from among the patch parameters based on the inference result.

Specifically, by generating a plurality of patches for each patch parameter by the planning function 113, a series of patches can be acquired for each patch parameter. The planning function 113 acquires the inference result based on the patches. Herein, the inference result includes the time and accuracy of inference based on the patches. Due to this, it is possible to obtain a trade-off curve representing a relation between the time and accuracy of the inference result illustrated in FIG. 6.

Inference results at respective points in the graph illustrated in FIG. 6 each correspond to one determined patch parameter and the patches that are generated and planned based on the patch parameter. For example, the inference result at a point indicated by a circle in FIG. 6 corresponds to the patch parameter and the patches illustrated in FIG. 5F.

In the first embodiment, the planning function 113 determines the optimized patch parameter and patches corresponding to the optimized patch parameter from among the patch parameters based on the inference accuracy and the inference time of the inference result.

Specifically, the planning function 113 sets thresholds for the inference accuracy and the inference time in advance. For example, the planning function 113 sets the threshold for the inference accuracy to be 97.2%. Due to this, the planning function 113 selects the inference result in which the inference time is the shortest, that is, selects the inference result indicated by the circle in FIG. 6, from among the inference results in which the inference accuracy exceeds the threshold of 97.2% on the curve illustrated in FIG. 6. Due to this, the planning function 113 determines the patch parameter corresponding to the inference result to be the optimized patch parameter, and determines the patches corresponding to the optimized patch parameter. The patches determined by the planning function 113 are illustrated in a right figure in FIG. 6.

The planning function 113 may further include an editing function 113D. The editing function 113D is an example of “editing”.

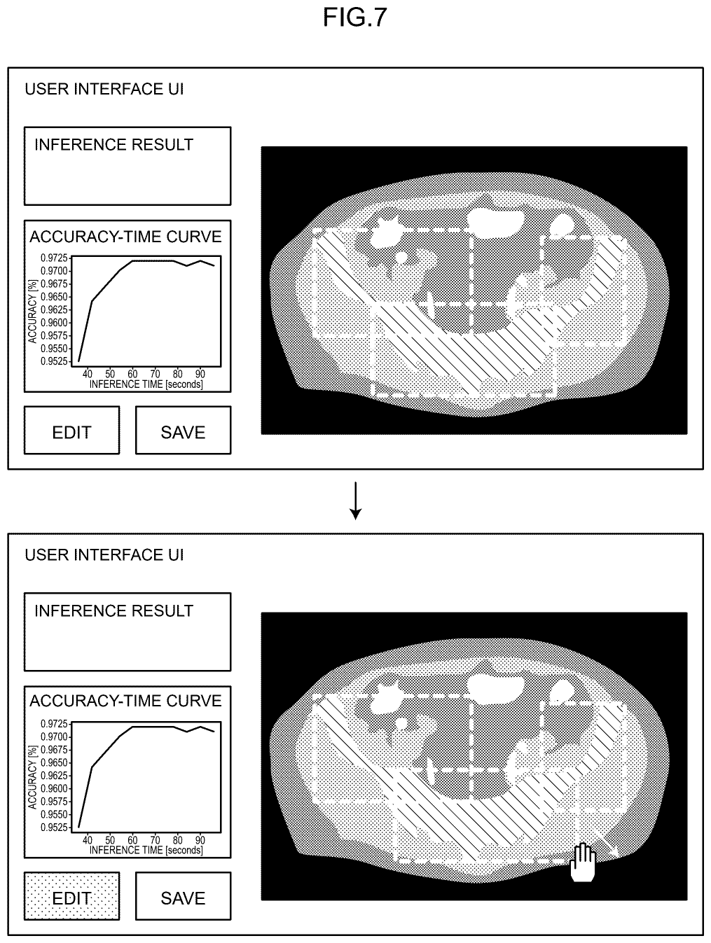

With reference to FIG. 7, the following describes the user interface UI for editing the patches by the editing function 113D. FIG. 7 is a schematic diagram illustrating the user interface UI for editing the patches by the editing function 113D.

As illustrated in FIG. 7, the editing function 113D displays, on the user interface UI, the inference result and the patches determined by the planning unit to be able to be edited by the user. The editing function 113D then adjusts the patches in accordance with editing by the user.

For example, when the user selects an “edit” button on the user interface UI, and moves a center patch among three patches toward a lower right side by a certain distance by an operation such as “drag” thereafter, the three patches after editing as illustrated in a lower figure in FIG. 7 are obtained. The editing by the user is not limited to moving the patch, but may also include changing the size of any of the patches, and adding or deleting a certain number of patches.

Due to this, the planning function 113 determines the optimized patch parameter and the patches corresponding to the optimized patch parameter.

The inference function 114 performs the inference task by performing inference on the image data using the deep learning model. Specifically, the inference function 114 performs the inference task using the deep learning model to acquire an inference result based on the optimized patch parameter and the patches corresponding to the optimized patch parameter determined by the planning function 113. The inference task is, for example, an image processing task such as segmentation, classification, and detection of the image based on the deep learning model. The inference function 114 may perform the inference task by combining a processing flow performed by the image processing device 1 with a method such as model pruning and model compression.

The output function 115 outputs various kinds of data and information. For example, the output function 115 outputs the inference result obtained by the inference function 114.

### Image Processing Method

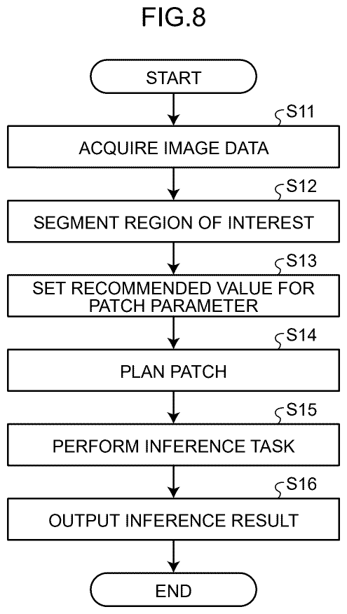

With reference to FIG. 8, the following describes a processing flow of the image processing method according to the first embodiment. FIG. 8 is a flowchart illustrating the image processing method according to the first embodiment.

At Step S11, the acquisition function 111 acquires image data. Next, the process proceeds to Step S12.

At Step S12, the segmentation function 41 of the image data preprocessing device 4 segments the image data acquired by the acquisition function 111 at Step S11 into the region of interest and the region of non-interest. Due to this, the region of interest is segmented in the image data. Next, the process proceeds to Step S13.

At Step S13, the setting function 112 sets a plurality of patch parameters corresponding to the inference task performed by the deep learning model on the image data. Specifically, the setting function 112 sets recommended values for the patch parameters based on parameters associated with the inference task in the history database DB stored in the medical data storage device 5. The setting function 112 may set the recommended values for the patch parameters based on an input by the user. The setting function 112 may generate a corresponding input image for each of the patch parameters at regular intervals in a preset range of the patch parameter, acquire an inference result of each input image, and determine the recommended value for the patch parameter based on the inference result. Due to this, the recommended values for the patch parameters are set corresponding to the inference task. Next, the process proceeds to Step S14.

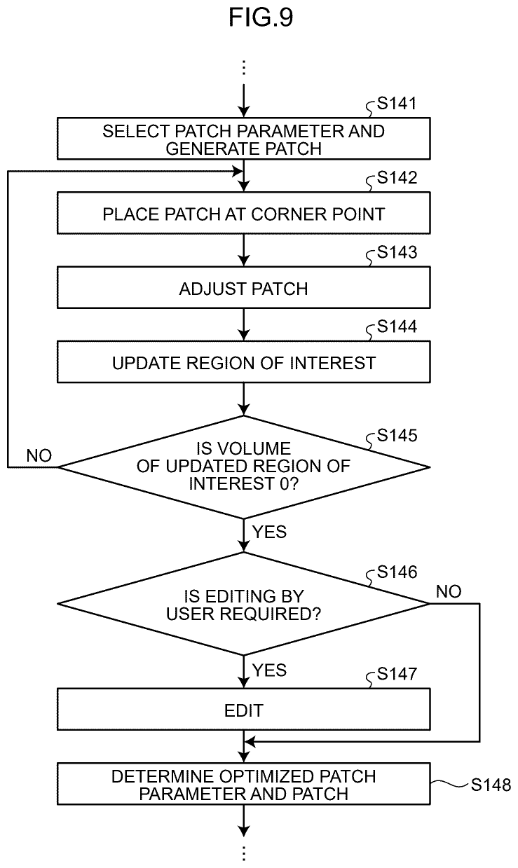

At Step S14, the planning function 113 generates a plurality of patches for each of the patch parameters set by the setting function 112 at Step S13, acquire an inference result based on the generated patches, and determines the optimized patch parameter and the patches corresponding to the optimized patch parameter from among the patch parameters based on the inference result. A flowchart of steps performed by the planning function 113 will be described later with reference to FIG. 9. Due to this, the optimized patch parameter and the patches corresponding to the optimized patch parameter are determined based on the inference result. Next, the process proceeds to Step S15.

At Step S15, the inference function 114 performs the inference task using the deep learning model to acquire the inference result based on the optimized patch parameter and the patches corresponding to the optimized patch parameter determined by the planning function 113 at Step S14. Due to this, the inference result based on the patches corresponding to the optimized patch parameter is obtained. Next, the process proceeds to Step S16.

At Step S16, the output function 115 outputs the inference result obtained by the inference function 114 at Step S15. Accordingly, the processing flow ends.

With reference to FIG. 9, the following describes a processing flow of planning of the patches according to the first embodiment. FIG. 9 is a flowchart illustrating planning of the patches according to the first embodiment.

At Step S141, the patch generation function 113A selects any one patch parameter from among reference values of the patch parameters set by the setting function 112, and generates the patch based on the selected patch parameter. Next, the process proceeds to Step S142.

At Step S142, the patch generation function 113A places the generated patch at a non-empty corner point position of the region of interest. Next, the process proceeds to Step S143.

At Step S143, the patch adjustment function 113B adjusts the patch generated by the patch generation function 113A. The patch adjustment function 113B then sets the size of the patch generated by the patch generation function 113A based on the patch parameter, adjusts the patch size corresponding to the length of the segmented region of interest, and moves the position of the patch after the size adjustment so that the range of the region of interest covered by the patch is increased while the range of the region of non-interest covered by the patch is reduced. Due to this, the size and the position of the patch generated by the patch generation function 113A are adjusted. Next, the process proceeds to Step S144.

At Step S144, the region-of-interest update function 113C subtracts the patch adjusted by the patch adjustment function 113B from the segmented region of interest in the image data and updates the region to a new region of interest. Next, the process proceeds to Step S145.

At Step S145, the planning function 113 determines whether the volume of the new region of interest updated by the region-of-interest update function 113C is zero. If it is determined that the volume of the updated new region of interest is zero, the process proceeds to Step S146. If it is determined that the volume of the updated new region of interest is not zero, the planning function 113 returns the processing flow to Step S142, and places the patch at another non-empty corner point position of the updated region of interest by the patch generation function 113A. A cycle of Step S142 to S144 is performed until the volume of the updated new region of interest becomes zero. In this manner, the planning function 113 generates and plans the patches for each of the patch parameters.

At Step S146, the planning function 113 determines whether editing by the user is required for the planned patches. If it is determined that editing by the user is required, the process proceeds to Step S147. If it is determined that editing by the user is not required, the process proceeds to Step S148.

At Step S147, the editing function 113D displays, on the user interface UI, the patches planned by the planning function 113 to be able to be edited by the user. The editing function 113D then adjusts the patches in accordance with editing by the user. Next, the process proceeds to Step S148.

At Step S148, the planning function 113 acquires the inference result based on the planed patches, and determines the optimized patch parameter and the patches corresponding to the optimized patch parameter among the patch parameters set by the setting function 112 based on the inference result. The processing flow of planning of the patches then ends, and the process proceeds to Step S15.

The planning function 113 ends the processing flow of planning the patches, the process proceeds to Step S15 described later, and the inference function 114 performs the inference task based on the planned patches.

Due to this, with the image processing device 1 and the image processing method according to the first embodiment, the patches can be dynamically adjusted to accelerate the inference process of the deep learning model, and can be applied to different inference tasks.

With the image processing device 1 and the image processing method according to the first embodiment, the inference process of the deep learning model can be dynamically adjusted according to actual needs, and the deep learning model can be trained based on a result of selection and editing by the user.

### Second Embodiment

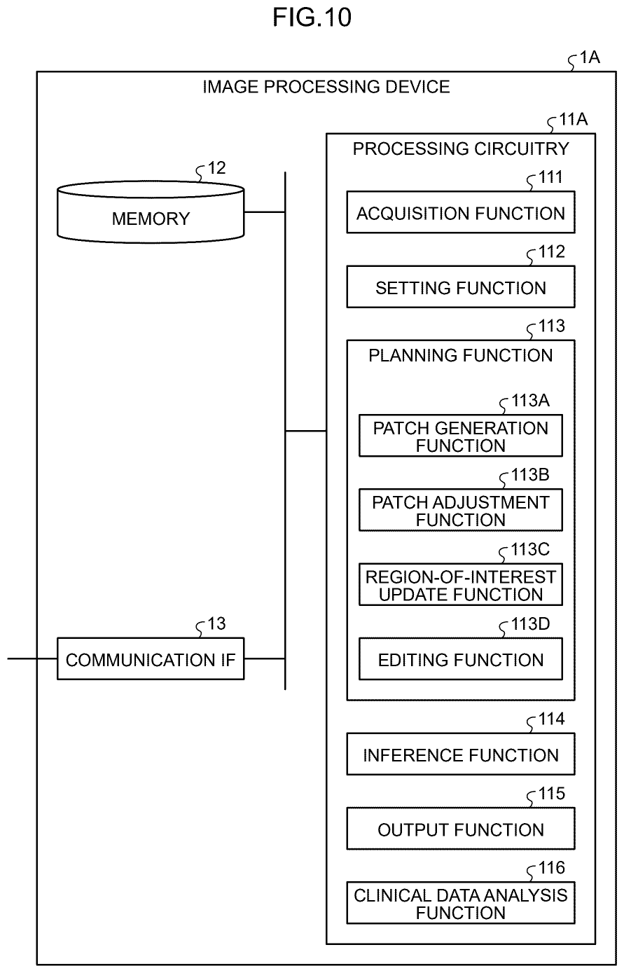

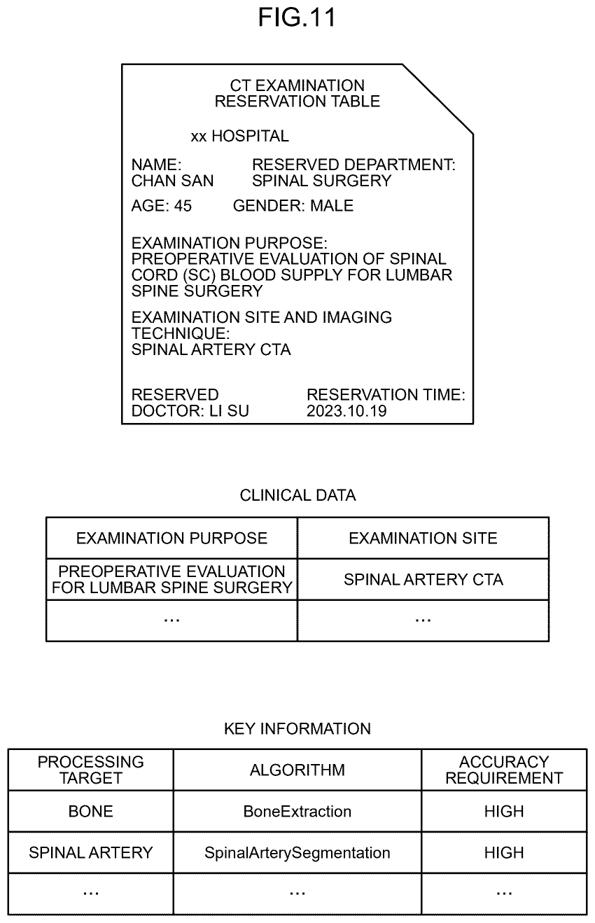

With reference to FIGS. 10 and 11, the following describes an image processing device 1A according to a second embodiment. FIG. 10 is a block diagram illustrating a configuration example of the image processing device 1A according to the second embodiment. FIG. 11 is a schematic diagram illustrating an example of clinical data and critical information. The following describes only differences between the second embodiment and the first embodiment, and common points will not be repeated.

The second embodiment is different from the first embodiment in that processing circuitry 11A of the image processing device 1A further includes a clinical data analysis function 116.

That is, as illustrated in FIG. 10, the processing circuitry 11A includes the acquisition function 111, the setting function 112, the planning function 113, the inference function 114, the output function 115, and the clinical data analysis function 116. Herein, the clinical data analysis function 116 is an example of “analyzing clinical data”.

The clinical data analysis function 116 extracts, from clinical data of a subject, critical information related to the inference task performed by the deep learning model. The planning function 113 then determines the optimized parameter and the patches corresponding to the optimized parameter based on the critical information in the clinical data of the subject extracted by the clinical data analysis function 116.

Specifically, the clinical data analysis function 116 acquires the clinical data of the subject from the medical data storage device 5, for example. For example, as illustrated in an upper figure of FIG. 11, the clinical data of the subject includes information such as personal information of the subject, an examination purpose, an examination department, an examination site, and an imaging technique. The clinical data analysis function 116 extracts critical information related to the inference task performed by the deep learning model from the clinical data of the subject, and as illustrated in a lower figure of FIG. 11, for example, extracts the fact that the examination purpose is preoperative evaluation for lumbar spine surgery and the examination site is a vertebral artery CTA as the critical information from the clinical data.

Next, the planning function 113 determines an inference target in the inference task based on the critical information extracted by the clinical data analysis function 116, and determines an algorithm and accuracy requirement for each inference target in accordance with a current clinical course. The planning function 113 determines the optimized patch parameter based on the accuracy requirement.

For example, in a typical thoracolumbar spine surgery, evaluation of a spinal artery, in particular, evaluation of a branch AKA (Adamkiewicz artery) of the spinal artery, is critically important, and if the branch AKA is damaged during surgery, there is a possibility of spinal cord ischemia. To perform evaluation of the branch AKA, bone removal processing needs to be performed on the image data. However, a diameter of the spinal artery is only 0.1 mm to 1.2 mm, so that bone detection accuracy is required to be very high in the bone removal processing.

Due to this, the planning function 113 determines the optimized patch parameter and the patches corresponding to the optimized patch parameter based on the critical information extracted by the clinical data analysis function 116.

The clinical data and the critical information of the clinical data described above are merely examples, and the information included therein is not limited thereto so long as the optimized patch parameter can be determined based on the critical information.

Accordingly, with the image processing method and the image processing device 1A according to the second embodiment, the optimized patch parameter can be determined and the patches corresponding thereto can be generated based on the critical information in the clinical data, the patch parameter can be optimized based on the clinical data, and the inference process of the deep learning model can be further accelerated.

### Third Embodiment

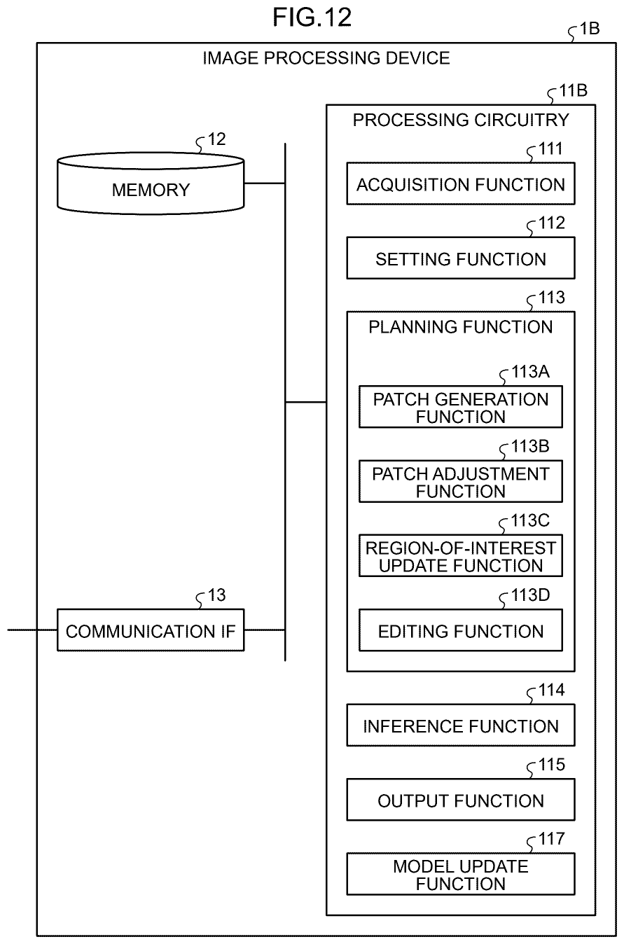

The following describes an image processing device 1B according to a third embodiment with reference to FIG. 12. FIG. 12 is a block diagram illustrating a configuration example of the image processing device 1B according to the third embodiment. The following describes only differences between the third embodiment and the first embodiment, and common points will not be repeated.

The third embodiment is different from the first embodiment in that processing circuitry 11B of the image processing device 1B further includes a model update function 117.

That is, as illustrated in FIG. 12, the processing circuitry 11B includes the acquisition function 111, the setting function 112, the planning function 113, the inference function 114, the output function 115, and the model update function 117. Herein, the model update function 117 is an example of “updating a model”.

The model update function 117 stores an editing result by the user on the optimized patch parameter and the patches corresponding to the optimized patch parameter determined by the planning function 113, and trains the deep learning model based on the editing result.

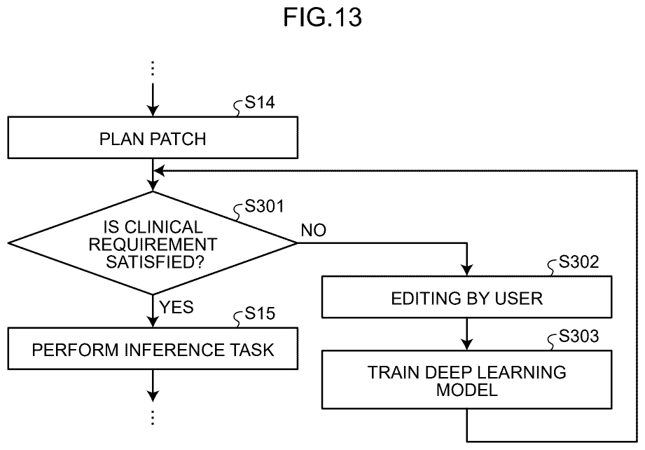

With reference to FIG. 13, the following describes a processing flow of model update by the model update function 117. FIG. 13 is a flowchart illustrating model update by the model update function 117.

As illustrated in FIG. 13, at Step S14, the planning function 113 determines the optimized patch parameter and the patches corresponding to the optimized patch parameter. Next, the process proceeds to Step S301.

At Step S301, the model update function 117 determines whether the optimized patch parameter and the patches corresponding to the optimized patch parameter determined by the planning function 113 satisfy a clinical requirement. If the model update function 117 determines that the optimized patch parameter and the patches corresponding to the optimized patch parameter determined by the planning function 113 satisfy the clinical requirement, the process proceeds to Step S15, and the inference function 114 performs the inference task based on the patches determined by the planning function 113 to perform inference.

If the model update function 117 determines that the optimized patch parameter and the patches corresponding to the optimized patch parameter determined by the planning function 113 do not satisfy the clinical requirement, the process proceeds to Step S302.

At Step S302, the model update function 117 presents the optimized patch parameter and the patches corresponding thereto that do not satisfy the clinical requirement to the user, and allows the user to edit them. The model update function 117 then stores an editing result by the user in the medical data storage device 5, for example. Next, the process proceeds to Step S303.

At Step S303, the model update function 117 trains the deep learning model based on the editing result by the user stored in the medical data storage device 5, and updates the deep learning model.

In the flowchart of the third embodiment illustrated in FIG. 13, Steps S14 and S15 are the same as those in the first embodiment, so that description thereof will not be repeated.

Due to this, with the image processing method and the image processing device 1B according to the third embodiment, the deep learning model can be continuously trained, and inference results optimized for different inference tasks can be multiplexed.

In the third embodiment, the processing circuitry 11B of the image processing device 1B may further include the clinical data analysis function 116 in the second embodiment.

### Comparative Example

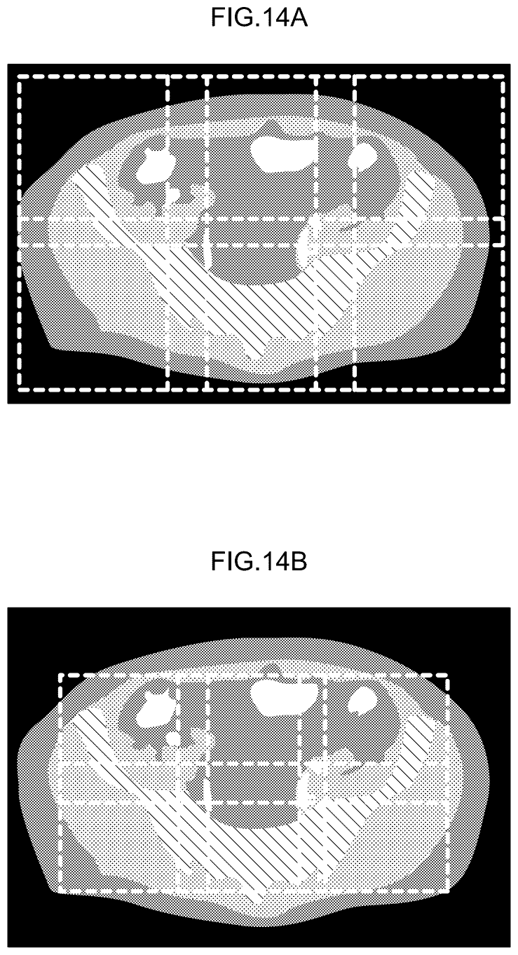

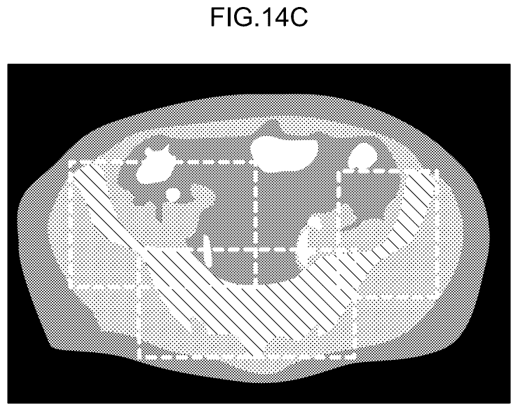

The following describes differences between a plurality of patches planned in a comparative example and the patches planned by the image processing method according to the present embodiment with reference to FIG. 14A to FIG. 14C. FIG. 14A to FIG. 14C are schematic diagrams for explaining differences between planning of the patches according to the comparative example and planning of the patches by the image processing method according to the present embodiment.

FIG. 14A and FIG. 14B illustrate the patches planned in the comparative example, and FIG. 14C illustrates the patches planned by the image processing method according to the present embodiment. Herein, in the comparative example in FIG. 14A, the patches are planned by using the Sliding-Window method. In the comparative example in FIG. 14B, the patches are planned by using a method combining the Sliding-Window method with the Coarse-to-fine method (Coarse-to-fine+Sliding-Window).

As illustrated in FIG. 14A to FIG. 14C, the patches planned by the Sliding-Window method have the same size, and the patches are uniformly distributed in the entire region of the image data. In the patches planned by the method combining the Sliding-Window method with the Coarse-to-fine method, distributed positions of the patches are improved and the patches are concentrated in the vicinity of the region of interest in the image data as compared with the patches planned by the Sliding-Window method. However, the patches still have the same size, and distribution of the patches is still uniform.

As compared with the comparative example, in the image processing method according to the present embodiment, appropriate patch parameters are set for different inference tasks, and appropriate patches are dynamically generated. Thus, the sizes and positions of the patches are adapted to the region of interest in the inference task. That is, the patches are distributed with appropriate sizes at appropriate positions that can cover the region of interest.

Thus, inference based on the appropriate patches can accelerate the inference process of the deep learning model, and can be applied to various different inference tasks.

In the embodiment described above, the processing circuitry is not limited to the processing circuitry implemented by a single processor, but may be configured by combining a plurality of independent processors, and processing functions may be implemented by the processors executing computer programs, respectively. The processing functions included in the processing circuitry may be implemented by being appropriately distributed or integrated in a single or a plurality of pieces of processing circuitry. The processing functions included in the processing circuitry may also be implemented by mixing hardware such as a circuit with software. Herein, exemplified is a case in which computer programs corresponding to the respective processing functions are stored in a single storage circuit, but the embodiment is not limited thereto. For example, the computer programs corresponding to the respective processing functions may be stored in a plurality of storage circuit in a distributed manner, and the processing circuitry may read out, from each storage circuit, and execute each computer program.

In the embodiments described above, exemplified is a case in which each of the functional units in the present specification is implemented by the processing circuitry, but the embodiment is not limited thereto. For example, each functional unit in the present specification is implemented by the processing circuitry described in the embodiment, but the same function may also be implemented by hardware only, software only, or a mixture of hardware and software.

A term of “processor” used in the description of the embodiment described above means, for example, a circuit such as a central processing unit (CPU), a graphics processing unit (GPU), an application specific integrated circuit (ASIC), or a programmable logic device (for example, a simple programmable logic device (SPLD), a complex programmable logic device (CPLD), and a field programmable gate array (FPGA)). Instead of storing the computer program in the storage circuit, the computer program may be directly incorporated in the circuit of the processor. In this case, the processor implements the function by reading out and executing the computer program incorporated in the circuit. Each of the processors in the present embodiment is not necessarily configured as a single circuit. A plurality of independent circuits may be combined to configure one processor, and implement the function thereof.

The “computer program” used in the description of the embodiments described above includes a computer program executed by the processor, and this computer program is embedded and provided in a read only memory (ROM), a storage circuit, or the like. The computer program may also be recorded and provided in a computer-readable non-transitory storage medium such as a compact disc (CD)-ROM, a flexible disk (FD), a CD-Recordable (R), or digital versatile disc (DVD), as a file in a format that can be installed in or executed by these devices. The computer program may also be stored in a computer connected to a network such as the Internet, and provided or distributed by being downloaded via the network. For example, the computer program is configured by a module including each of the processing functions described above. As actual hardware, when a CPU reads out, from a storage medium such as a ROM, and executes a computer program, each module is loaded on a main storage device and generated on the main storage device.

In the embodiments described above, the components of the devices illustrated in the drawings are merely conceptual, and it is not required that they are physically configured as illustrated necessarily. That is, specific forms of distribution and integration of the devices are not limited to those illustrated in the drawings, and all or part thereof may be functionally or physically distributed or integrated in arbitrary units depending on various loads or usage states. Furthermore, all or optional part of the processing functions executed by the respective devices may be implemented by a CPU and a computer program analyzed and executed by the CPU, or may be implemented as hardware using wired logic.

Among the pieces of processing described in the embodiments described above, all or part of the pieces of processing described to be automatically performed can be manually performed, or all or part of the pieces of processing described to be manually performed can be automatically performed using a well-known method. Additionally, information including a processing procedure, a control procedure, a specific name, various kinds of data and parameters described in this document and illustrated in the drawings can be optionally changed unless otherwise specifically noted.

The various kinds of data handled in the present specification are typically digital data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing method for performing an inference task on image data using a trained deep learning model, the image processing method comprising:
setting a plurality of patch parameters corresponding to the inference task;
planning by generating a plurality of patches for each of the patch parameters, acquiring an inference result based on the generated patches, and determining an optimized patch parameter and patches corresponding to the optimized patch parameter from among the patch parameters based on the inference result; and
inferring by performing the inference task using the deep learning model to acquire an inference result based on the patches corresponding to the determined optimized patch parameter.

2. The image processing method according to claim 1, wherein
the planning further includes:
generating the patches for each of the patch parameters;
adjusting the patches; and
updating a region of interest by subtracting the patches from a region of interest in the image data and updating the region of interest to a new region of interest, and
in the new region of interest, the patches are generated by performing the generating the patches, the adjusting the patches, and the updating the region of interest until a volume of the updated new region of interest becomes zero.

3. The image processing method according to claim 2, wherein
at the generating the patches,
each of the patches is generated at a position of a corner point of the region of interest, and
at the adjusting the patches,
a size of each patch is set based on the patch parameter,
the size of the patch is adjusted in accordance with a length of the region of interest, and
a position of the adjusted patch is moved so that a range of the region of interest covered by the patch is increased and a range of a region of non-interest covered by the patch is reduced.

4. The image processing method according to claim 1, wherein
at the setting, recommended values for the patch parameters are set based on a parameter associated with the inference task in a history database, and
at the planning, a plurality of patches are generated for each of the patch parameters in the recommended values.

5. The image processing method according to claim 1, wherein
at the setting, recommended values for the patch parameters are set based on an input by a user, and
at the planning, a plurality of patches are generated for each of the patch parameters in the recommended values.

6. The image processing method according to claim 1, wherein
at the setting, a corresponding input image is generated for each of the patch parameters at regular intervals in a preset range of the patch parameter, an inference result of each input image is acquired, and a recommended value for the patch parameter is determined based on the inference result, and
at the planning, a plurality of patches are generated for each of the patch parameters in the recommended values.

7. The image processing method according to claim 4, wherein the patch parameters include a base patch size, a patch size ratio, base resolution, and a resolution ratio.

8. The image processing method according to claim 5, wherein the patch parameters include a base patch size, a patch size ratio, base resolution, and a resolution ratio.

9. The image processing method according to claim 6, wherein the patch parameters include a base patch size, a patch size ratio, base resolution, and a resolution ratio.

10. The image processing method according to claim 1, wherein at the planning, the optimized patch parameter and the patches corresponding to the optimized patch parameter are determined based on inference accuracy and an inference time.

11. The image processing method according to claim 1, wherein
the planning further includes editing, and
at the editing, the inference result and the determined patches are displayed on a user interface to be able to be edited by a user, and the patches are adjusted in accordance with editing by the user.

12. The image processing method according to claim 1, further comprising:
acquiring the image data;
segmenting the image data to extract a region of interest; and
outputting the inference result.

13. The image processing method according to claim 1, further comprising:
analyzing clinical data by extracting critical information related to the inference task from clinical data of a subject, wherein
at the planning, the optimized patch parameter and patches corresponding to the optimized patch parameter are determined based on the critical information.

14. The image processing method according to claim 1, further comprising:
updating the deep learning model by storing an editing result by a user, and training the deep learning model based on the editing result.

15. An image processing device configured to perform an inference task on image data using a trained deep learning model, the image processing device comprising processing circuitry configured to:
set a plurality of patch parameters corresponding to the inference task;
generate a plurality of patches for each of the patch parameters, acquire an inference result based on the generated patches, and determine an optimized patch parameter and patches corresponding to the optimized patch parameter from among the patch parameters based on the inference result; and
perform the inference task using the deep learning model to acquire an inference result based on the patches corresponding to the determined optimized patch parameter.

16. A non-transitory computer-readable recording medium storing therein a computer program configured to, when executed by a processor, perform an inference task on image data using a trained deep learning model that causes a computer to executed:
setting a plurality of patch parameters corresponding to the inference task;
planning by generating a plurality of patches for each of the patch parameters, acquiring an inference result based on the generated patches, and determining an optimized patch parameter and patches corresponding to the optimized patch parameter from among the patch parameters based on the inference result; and
inferring by performing the inference task using the deep learning model to acquire an inference result based on the patches corresponding to the determined optimized patch parameter.
